(19) United States
(12) Patent Application Publication
(10) Pub. No.: US 2011/0292942 A1
(43) Pub. Date: Dec. 1, 2011

(54) ROUTER, INFORMATION PROCESSING DEVICE AND PROGRAM

(75) Inventor: Yuji IMAI, Kawasaki (JP)

(73) Assignee: FUJITSU LIMITED, Kawasaki-shi (JP)

(21) Appl. No.: 13/107,085

(22) Filed: May 13, 2011

(30) Foreign Application Priority Data
May 27, 2010 (JP) 2010-122130

(51) Int. Cl. H04L 12/56

(52) U.S. Cl. 370/392

(57) ABSTRACT

A router has a sending module that sends information to a data center connected with a wide-area-network when the router has been connected with the wide-area-network, the information being registered in the router beforehand and including information relating to an information-management-device that starts up a virtual machine and a virtual router, an opening module that acquires a protocol setting information from the data center and opens a channel leading to a gateway in the data center on the basis of the protocol setting information, and a communication module that acquires an address of the virtual router to be connected with the virtual machine which has been started up on the basis of the information relating to the information-management-device from the data center and communicates with the virtual router via the channel on the basis of the acquired address of the virtual router.

### CROSS-REFERENCE TO RELATED APPLICATION

This application is based upon and claims the benefit of priority of the prior Japanese Patent Application No. 2010-122130, filed on May 27, 2010 the entire contents of which are incorporated herein by reference.

### FIELD

The application relates to a router, an information processing device and a program.

### BACKGROUND

A first technique of facilitating setting of connection with Internet in a router which is performed by a router purchaser by acquiring setting information of the router to be connected with an Internet Service Provider (ISP) is known (see, for example, Japanese Laid-open Patent Publication No. 2004-199652). In the above mentioned technique, when the router has been connected with a modem, the router gains access to a broadband access server and is authenticated by a RADIUS (Remote Authentication Dial In User Service) server. Then, the router is authenticated as equipment to be connected with the network concerned by an equipment authentication server (a server that handles authentication of equipment to be connected with the network concerned). Then, the router acquires setting information which becomes desirable in connecting the router with an ISP server from an ISP download server. The router sets the acquired setting information in itself and is connected with the ISP server on the basis of the setting information to acquire HTML (Hyper Text Markup Language) of a Web page in Internet via the ISP server.

A second technique of sending a server identification information of a karaoke (singing to tapes accompaniment) device and identification information of a router over a WAN (Wide Area Network) is also known (see, for example, Japanese Laid-open Patent Publication No. 2004-109263).

Further, a third technique of utilizing a system that utilizes a virtual machine in a cloud data center over an intranet of a user is known. In the above mentioned system, a physical server in the cloud data center starts up a virtual machine that executes a task of the user and provides a terminal (for example, a computer) which is connected with the intranet of the user with a service which is desirable for execution of the task of the user.

In the above mentioned third technique, in some cases, it may be unavoidable for an engineer of the cloud data center to design logics of the system including the virtual machine and to perform an operation of constructing the system as demanded by the user. In addition, it may be also unavoidable for the user to perform a setting operation for connecting the terminal with the virtual machine in the cloud data center. Thus, such a problem may generate that burdens are imposed on the engineer of the cloud data center and the user in performing the operations.

In addition, even in the case that the router is installed in the intranet of the user as in the above mentioned first and second techniques, the terminal of the user is simply connected with the network installed outside of the intranet and it is not the case that the user is allowed to gain access to the virtual machine in the cloud data center.

### SUMMARY

According to an embodiment, a router includes sending means that sends data center which is connected with a wide area network information which is registered in advance and relates to an information management device that starts up a virtual machine and a virtual router when a router has been connected with the wide area network, opening means that acquires protocol setting information for a virtual private communication network (setting information of a protocol for use in a virtual private communication network) from the data center and opens a channel leading to a gateway in the data center on the basis of the acquired protocol setting information for a virtual private communication network and communication means that acquires the address of a virtual router to be connected with the virtual machine which has been started up in the data center on the basis of the information relating to the information management device from the data center and communicates with the virtual router via the channel leading to the gateway in the data center on the basis of the acquired address of the virtual router.

According to an embodiment, an information processing device includes receiving means that receives information relating to an information management device that starts up a virtual machine and a virtual router from a router when the router has been connected with a wide area network, first acquiring means that acquires information on an information management device to be started up, a virtual machine to be started up, a virtual router to be started up and a gateway to be started up which is held in the data center on the basis of the received information relating to the information management device, second acquiring means that acquires two pieces of protocol setting information for a virtual private communication network from a telecommunications carrier, first sending means that sends the router one piece of the acquired protocol setting information for a virtual private communication network and sends a gateway corresponding to the information on the gateway to be started up the other piece of the acquired protocol setting information for a virtual private communication network, instructing means that instructs the information management device to start up a virtual machine and a virtual router corresponding to the information on the virtual machine to be started and the virtual router to be started up and second sending means that sends the router the address of the started-up virtual router and sends the started-up virtual router the address of the router.

According to an embodiment, a program makes a computer function as receiving means that receives information relating to an information management device that starts up a virtual machine and a virtual router from a router when the router has been connected with a wide area network, first acquiring means that acquires information on an information management device to be started up, a virtual machine to be started up, a virtual router to be started up and a gateway to be started up which is held in the data center on the basis of the received information relating to the information management device, second acquiring means that acquires two pieces of protocol setting information for a virtual private communication network from a telecommunications carrier, first sending means that sends the router one piece of the acquired protocol setting information for a virtual private communication network and sends a gateway corresponding to the information on the gateway to be started up the other piece of the acquired protocol setting information for a virtual private communication network, instructing means that instructs the information management device to start up a virtual machine and a virtual router corresponding to the information on the virtual machine to be started and the virtual router to be started up and second sending means that sends the router the address of the started-up virtual router and sends the started-up virtual router the address of the router.

### BRIEF DESCRIPTION OF DRAWINGS

FIG. 1 is a diagram illustrating an example of a configuration of an information management system including a router according to an embodiment;

FIG. 2 is a diagram illustrating an example of a configuration of a data base;

FIG. 3A is a block diagram illustrating an example of a hardware configuration of a management server;

FIG. 3B is a block diagram illustrating an example of a functional configuration of a router management unit 16 of the management server;

FIG. 4A is a diagram illustrating an example of a hardware configuration of a router;

FIG. 4B is a block diagram illustrating an example of a functional configuration of the router;

FIG. 5 is a flowchart illustrating an example of a process that the router executes;

FIG. 6 is a flowchart illustrating an example of a process that the router management unit executes; and

FIG. 7 is a diagram illustrating an example of a sequence of processes that an information management system executes.

### DESCRIPTION OF EMBODIMENTS

Next, preferred embodiments of the application are described with reference to the accompanying drawings.

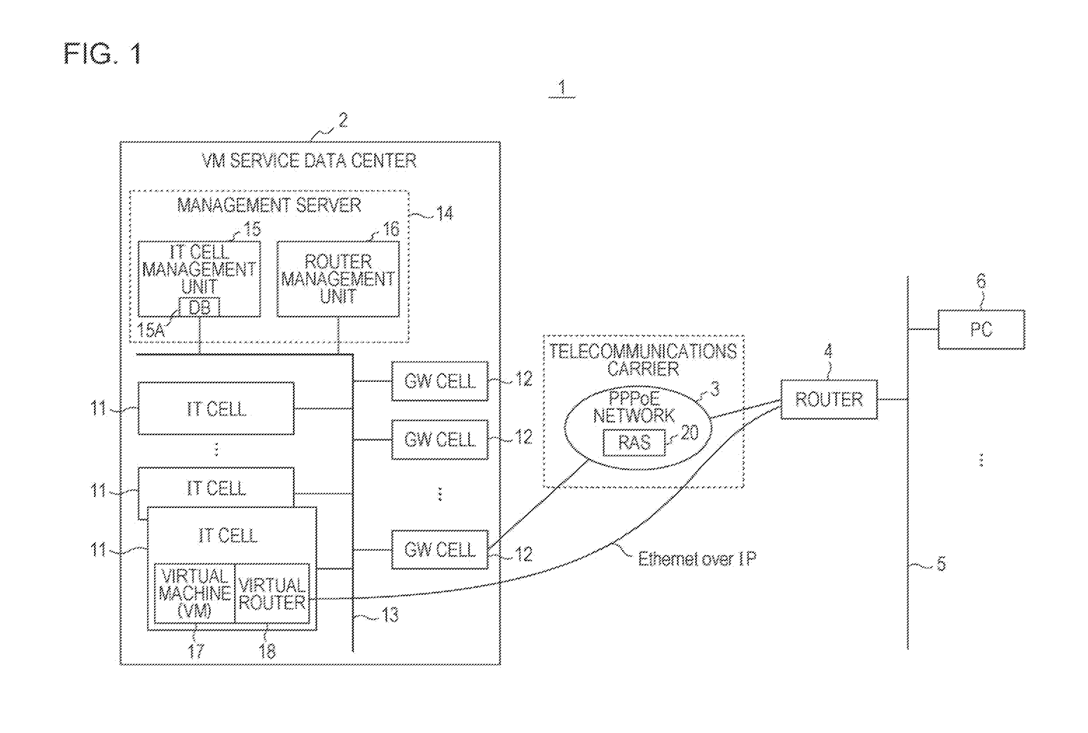

FIG. 1 is a diagram illustrating an example of a configuration of an information management system including a router according to an embodiment of the application.

An information management system 1 includes a VM (Virtual Machine) service data center 2, a PPPoE (Point to Point Protocol over Ethernet (a registered trademark)) network 3 that a telecommunications carrier provides, a router 4, a user's intranet 5, and a user PC (Personal Computer) 6. The PPPoE is a protocol that utilizes the function of PPP (Point to Point Protocol) over Ethernet (a registered trademark) and a protocol used in a virtual private communication network which is described later. The PPPoE network 3 is a WAN (Wide Area Network).

The VM service data center 2 is a cloud service center that provides the user PC 6 with services such as, for example, a software package, a platform used for execution of an application and the like over the PPPoE network 3. The VM service center 2 includes a plurality of IT (Information Technology) cells 11 configured using physical servers, a plurality of GW (Gateway) cells 12 configured using gateway servers, and a management server 14. The management server 14 is connected with the plurality of IT cells 11 and the plurality of GW cells 12 over a LAN (Local Area Network) 13. The IT cell 11 is an example of an information processing device. The management server 14 is an example of an information management device.

The IT cell 11 includes a virtual machine 17 that starts up a service to be provided to the user PC 6 and a virtual router 18 that controls outputting of data from the virtual machine 17 and inputting of data into the virtual machine 17. The virtual machine 17 is connected with the virtual router 18 in one-to-one correspondence. The IT cell 11 may include a plurality of virtual machines 17 and a plurality of virtual routers 18. The virtual machine 17 starts up a virtual OS and an application to be provided to a user. The virtual machine 17 and the virtual router 18 are implemented in software. The virtual router 18 is a firewall router that accepts only access from a specific user PC.

The GW cell 12 includes a gateway program and executes the gateway program to act as a go-between for data communication between the virtual router 18 and the PPPoE network 3.

The management server 14 includes an IT cell management unit 15 and a router management unit 16. The IT cell management unit 15 includes a data base (DB) 15A.

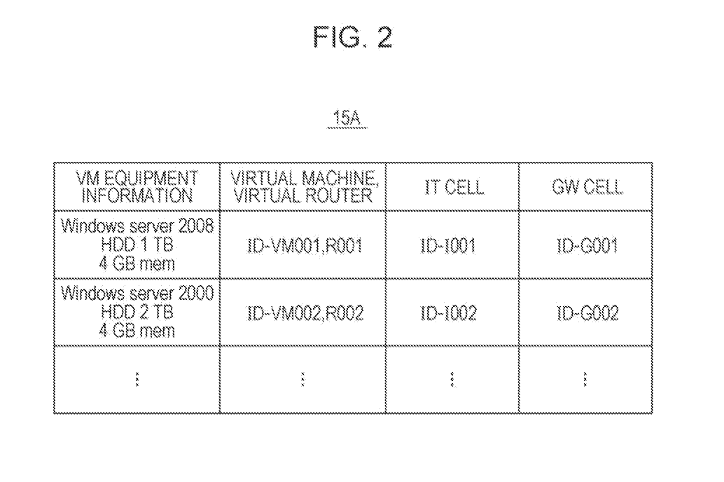

FIG. 2 is a diagram illustrating an example of a configuration of the data base 15A. In the data base 15A, ID numbers of the virtual machines, the virtual routers, the IT cells and the GW cells are registered in correspondence with VM equipment information received from the router 4. The VM equipment information (information relating to an information management device) is information used to specify one of the IT cells 11 that starts up the virtual machine 17 concerned and the virtual router 18 concerned. Specifically, it is information on an OS (Operation System) that the IT cell 11 includes and hardware that the IT cell 11 includes.

The IT cell management unit 15 that receives the VM equipment information from the router 4 selects one virtual machine 17, one virtual router 18, one IT cell 11 and one GW cell 12 which are registered in the data base 15A. Then, the IT cell management unit 15 starts up the selected IT cell 11 and the selected GW cell 12 and makes the selected IT cell 11 start up the selected virtual machine 17 and the selected virtual router 18.

The IT cell management unit 15 manages the operation of each IT cell 11. The router management unit 16 establishes PPPoE session-based communication between the router 4 and the GW cell 12 over an IP-VPN (IP-Virtual Private Network) that a telecommunications carrier has opened. The IP-VPN is a virtual private communication network (VPN) which is constructed over a wide area IP communication network that the telecommunications carrier holds. In the example illustrated in FIG. 1, the IP-VPN is a virtual private communication network (VPN) that connects the VM service data center 2 with the router 4 over the PPPoE network 3. As examples of the IP-VPN, FLET'S. VPN Wide, FENICS Business IP Network Service and the like that telecommunications carriers provide may be given.

In addition, the router management unit 16 notifies the router 4 of the IP address of the virtual router 18 and notifies the virtual router 18 of the IP address of the router 4 to establish “Ethernet over IP”-based communication between the router 4 and the virtual router 18. Further, the router management unit 16 requests the IT cell management unit 15 to allocate the GW cell 12 that executes PPPoE session-based communication to the IT cell 11 that starts up the virtual machine 17. Although, in the example illustrated in FIG. 1, the IT cell management unit 15 and the router management cell 16 are included in one management server, these units may be installed in separate servers.

The telecommunications carrier provides the VM service data center 2 and the router 4 with the PPPoE network 3 that serves as an IP-VPN for optical communication (FTTH (Fiber To The Home)) between them. In addition, the telecommunications carrier includes a RAS (Remote Access Service) 20 which is a service for connection with a computer network installed in a remote area and executes PPPoE session-based communication between the virtual router 18 and the router 4 using the RAS 20.

In the information management system 1 which is configured as mentioned above, when the user connects the router 4 between the PPPoE network 3 and the user's intranet 5, the VM service data center 2 automatically creates a state in which the user PC 6 is allowed to use the virtual machine 17 that operates in the IT cell 11.

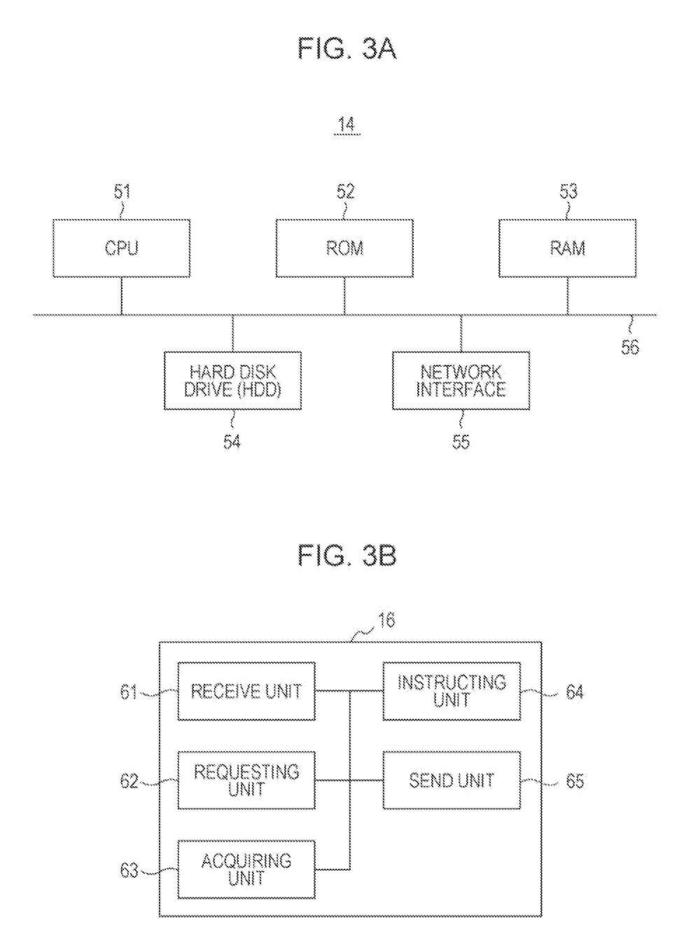

FIG. 3A is a block diagram illustrating an example of a hardware configuration of the management server 14. FIG. 3B is a block diagram illustrating an example of a functional configuration of the router management unit 16 of the management server 14.

In FIG. 3A, the management server 14 includes a CPU 51 that controls the operation of the entire management server 14, a ROM 52 that holds control programs, and a RAM 53 that functions as a working area. The management server also includes a hard disk drive (HDD) 54 that holds various pieces of information and various programs, and a network interface 55 used for connection with the LAN 13. The CPU 51 is connected with the ROM 52, the RAM 53, the HDD 54 and the network interface 55 via a system bus 55. The CPU 51 executes the control programs stored in the ROM 52 or the HDD 54 to implement the IT cell management unit 15 and the router management unit 16 illustrated in FIG. 1. The data base 15A is stored in the HDD 54.

The hardware configurations of the IT cell 11 and the GW cell 12 are the same as that of the management server 14 and hence description of the hardware configurations of the IT cell 11 and the GW cell 12 may be omitted.

As illustrated in FIG. 3B, the router management unit 16 includes a receive unit 61, a requesting unit 62, an acquiring unit 63, an instructing unit 64 and a send unit 65.

The receive unit 61 receives VM equipment information from the router 4 when the router 4 has been connected between the PPPoE network 3 and the user's intranet 5. The requesting unit 62 requests the telecommunications carrier to open an IP-VPN for use in the operation stage and prepare two pieces of operation stage use PPPoE setting information (setting information of a PPPoE for use in the operation stage). The acquiring unit 63 acquires information on an IT cell 11 to be started up, a virtual machine to be started up, a virtual router to be started up and a GW cell 12 to be started up which is held in the VM service data center 2 on the basis of the VM equipment information. Incidentally, the information on the IT cell 11 to be started up is the ID used to specify that IT cell 11. The information on the virtual machine 17 to be started up is the ID used to specify that virtual machine 17. The information on the virtual router 18 to be started up is the ID used to specify that virtual router 18. The information on the GW cell 12 to be started up is the ID used to specify that GW cell 12.

In addition, the acquiring unit 63 acquires two pieces of operation stage use PPPoE setting information from the telecommunications carrier. The operation stage use PPPoE setting information is described later. The instructing unit 64 instructs the IT cell management unit 15 to start up the virtual machine 17 and the virtual cell 18 respectively corresponding to the information on the virtual machine 17 to be started up and the virtual router 18 to be started up. The send unit 65 sends the router 4 one piece of the acquired operation stage use PPPoE setting information and sends the GW cell 12 corresponding to the information on the GW cell 12 to be started up the other piece of the acquired operation stage use PPPoE setting information. In addition, the send unit 65 sends the router 4 the IP address of the virtual router 18 which has been started up and sends the started-up virtual router 18 the IP address of the router 4.

The receive unit 61, the acquiring unit 65 and the send unit 65 are implemented using the CPU 51 and the network interface 55. The CPU 51 executes predetermined control programs to implement the requesting unit 62 and the instructing unit 64. Incidentally, the receive unit 61 is an example of the above mentioned receiving means. The acquiring unit 63 is an example of the above mentioned first acquiring means and second acquiring means. The send unit 65 is an example of the above mentioned first sending means and second sending means. The instructing unit 64 is an example of the above mentioned instructing means.

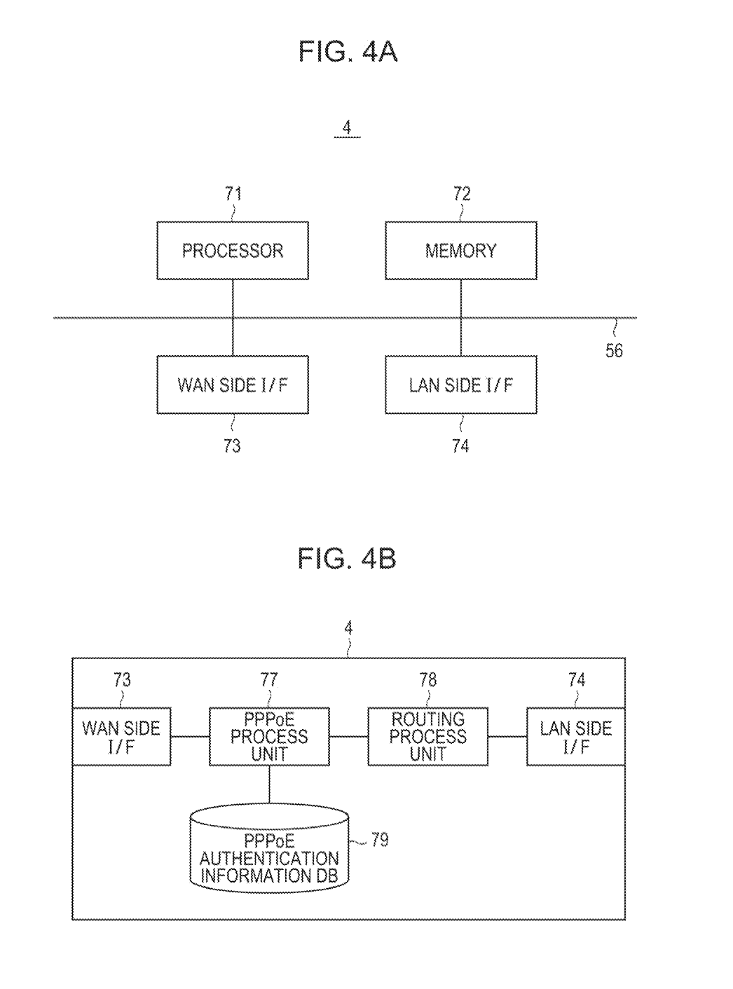

FIG. 4A is a block diagram illustrating an example of a hardware configuration of the router 4. FIG. 4B is a block diagram illustrating an example of a functional configuration of the router 4.

As illustrated in FIG. 4A, the router 4 includes a processor 71 that controls the entire operation of the router 4 and a memory 72 that stores control programs and data. The router 4 also includes a WAN side interface 73 that connects the router 4 with the PPPoE network 3 and a LAN side interface 74 that connects the router 4 with the user's intranet 5. The processor 71 is connected with the memory 72, the WAN side interface 73 and the LAN side interface 74 via a bus 75.

The memory 72 stores a script used for connection with a virtual machine, setting stage use PPPoE setting information (setting information of a PPPoE for use in the setting stage) and the VM equipment information. The setting stage use PPPoE setting information includes the PPPoE user name (the name of the user of the PPPoE concerned) and the password of that user. The setting stage use PPPoE setting information is information on the basis of which the router 4 is first connected with the VM service data center 2 over the PPPoE network 3 using the PPPoE. The PPPoE user name is expressed in the form of, for example, “faucet-user-123456©facet.sop.fujitsu.com” and includes the domain name that specifies the VM service data center 2 and the ID inherent to the router 4.

As illustrated in FIG. 4B, the router 4 includes a PPPoE process unit 77, a routing process unit 78, a PPPoE authentication information data base (DB) 79, the above mentioned WAN side interface 73 and the above mentioned LAN side interface 74. The PPPoE authentication information DB 79 stores the setting stage use PPPoE setting information. The PPPoE authentication information DB 79 is stored in the memory 72. As an example of the above mentioned sending means and opening means, the PPPoE process unbit 77 may be given. As an example of the above mentioned communication means, the routing process unit 78 may be given.

The PPPoE process unit 77 executes a process of first connecting the router 4 with the VM service data center 2 over the PPPoE network using the setting stage use PPPoE setting information which is stored in the PPPoE authentication information DB 79. In addition, the PPPoE process unit 77 executes a process of connecting the router 4 with the VM service data center 2 over the PPPoE network using the operation stage use PPPoE setting information. The operation stage use PPPoE setting information includes the PPPoE-ID and the password used to connect the router 4 with the IP-PVN for use in the operation stage and is acquired from the router management unit 16. The operation stage use PPPoE setting information is an example of the above mentioned protocol setting information for a virtual private communication network. The IP-PVN for use in the operation stage is a virtual private communication network (VPN) for use in the operation stage including a channel running from the VM service data center 2 to the router 4. The reason why the setting stage use PPPoE setting information is prepared separately from the operation stage use PPPoE setting information lies in that it sometimes occurs that the GW cell 12 utilized in the setting stage is different from the GW cell 12 which is started up in the operation stage.

The routing process unit 78 acquires the IP address of the virtual router 18 that the IT cell management unit 15 has selected from the router management unit 16 to execute “Ethernet over IP”-based communication with the virtual router 18 that the IT cell management unit 15 has selected. Owing to the above mentioned operation, “Ethernet over IP”-based data communication is executed between the user PC 6 and the virtual machine 17 that the IT cell management unit 15 has selected. The “Ethernet over IP” is a function of IP-packetizing data (specifically, an Ethernet frame) and sending/receiving the packetized data. The processor 71 implements the PPPoE process unit 77 and the routing process unit 78 by executing the control programs stored in the memory 2.

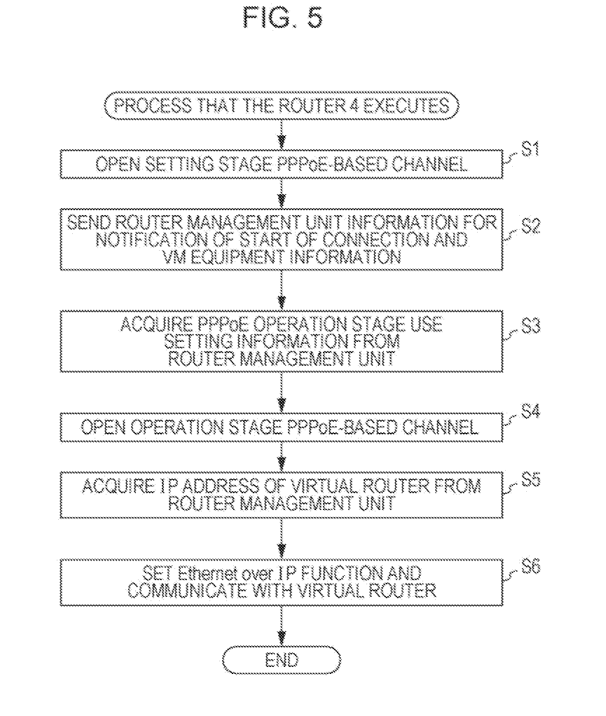

FIG. 5 is a flowchart illustrating an example of a process that the router 4 executes.

Prior to explanation of the above mentioned process, it is supposed that a user connects an optical communication cable with the WAN side interface 73 of the router 4, connects a LAN cable with the LAN side interface 74 of the router 4, and then turns the power source of the router 4 on.

First, the PPPoE process unit 77 opens a channel leading to the GW cell 12 which is set up on the basis of a setting stage PPPoE using setting stage use PPPoE setting information which is stored in the PPPoE authentication information DB 79, that is, connects the router 4 with an IP-VPN for use in the setting stage (step S1). As a result of execution of the process at step S1, the router 4 gains access to one GW cell 12 in the VM service data center 2 over the PPPoE network 3.

Next, the PPPoE process unit 77 sends the router management unit 16 information for notification of start of connection and the VM equipment information stored in the PPPoE authentication information DB 79 (step S2). The information for notification of start of connection is, for example, a packet indicating start of connection. In addition, in the case that the host name of the router management unit 16 is “faucet-mng.cloud.fujitsu.com”, the PPPoE process unit 77 sends the destination “http://faucet-mng.cloud.fujitsu.com” the packet indicating start of connection and the VM equipment information.

Next, the PPPoE process unit 77 acquires operation stage use PPPoE setting information, that is, one PPPoE-ID and one password from the router management unit 16 as a reply to the VM equipment information so sent (step S3). The PPPoE process unit 77 opens a channel leading to the started-up GW cell 12 which is set up on the basis of an operation stage PPPoE using the PPPoE-ID and the password acquired from the router management unit 16. That is, the PPPoE process unit 77 connects the router 4 with an IP-VPN for use in the operation stage (step S4). As a result of execution of the process at step S4, the router 4 is allowed to be connected with the started-up GW cell 12 over the virtual private communication network using Ethernet.

Then, the routing process unit 78 acquires the IP address of the virtual router 18 that the IT cell management unit 15 has selected from the router management unit 16 (step S5). For example, the routing process unit 78 acquires the IP address of the virtual router 18 that the IT cell management unit 15 has selected from “http://faucet-mng.cloud.fujitsu.com/ether ip-pa ram” which is the destination in which the IP address of the virtual router 18 in the router management unit 16 is registered.

The routing process unit 78 sets the “Ethernet over IP” function, that is, the function of IP-packetizing data and sending the IP packetized data to the virtual router 18 that the IT cell management unit 15 has selected and receiving it from the above mentioned virtual router 18. Owing to the above mentioned operation, it is allowed to create a state in which it seems as though the router 4 is coupled directly with the virtual machine 17 which is connected with the virtual router 18 that the IT cell management unit 15 has selected over Ethernet. Simultaneously with the above mentioned operation, the routing process unit 78 communicates the virtual router 18 that the IT cell management unit 15 has selected via a channel running from the started-up GW cell 12 to the router 4 on the basis of the acquired IP address of the virtual router 18 (step S6).

As a result of execution of the processes from step S1 to step S6, the user PC 6 is allowed to gain access to the virtual machine 17 via the router 4, the PPPoE network 3 (the IP-VPN), the GW cell 12 and the virtual router 18.

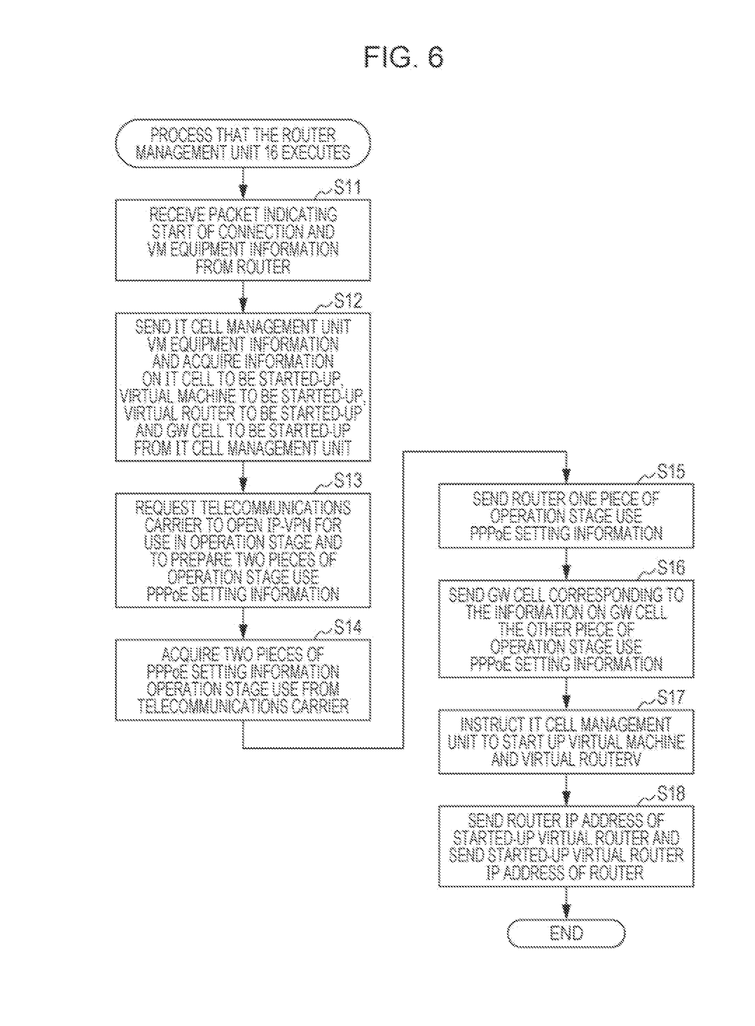

FIG. 6 is a flowchart illustrating an example of processes that the router management unit 16 executes.

The receive unit 61 receives a packet indicating start of connection and VM equipment information from the router 4 (step S11). The acquiring unit 63 sends the IT cell management unit 15 the VM equipment information. Then, the acquiring unit 63 acquires information on a virtual machine to be started-up, a virtual router to be started-up, an IT cell to be started-up and a GW cell to be started-up from the IT cell management unit 15 (step S12).

The requesting unit 62 requests a telecommunications carrier to open an PI-VPN for use in the operation stage and two pieces of operation stage use PPPoE setting information (step S13). In the example illustrated in the drawing, the requesting unit 62 gains access to the site (for example, “FLET'S Optical Next, Service Application Receiving Page, FLET'S VPN-Wide Setting Menu”) of the telecommunications carrier to request for the above. As an alternative, with respect to the process at step S13, the manager of the VM service data center 2 may request the telecommunications carrier to open the IP-VPN for use in the operation stage and to prepare two pieces of operation stage use PPPoE setting information. Then, the telecommunications carrier opens the IP-VPN for use in the operation stage.

The acquiring unit 62 acquires two pieces of operation stage use PPPoE setting information from the telecommunications carrier (step S14). Then, the send unit 65 sends the router 4 one piece of the acquired operation stage use PPPoE setting information (step S15). As a result of execution of the process at step S15, the PPPoE process unit 77 of the router 4 opens a channel leading to the GW cell 12 corresponding to the information of the GW cell which has been acquired at step S12 with the use of the operation stage use PPPoE setting information. The send unit sends the GW cell 12 corresponding to the information of the GW cell which has been acquired at step S12 the other piece of the acquired operation stage use PPPoE setting information (step S16). As a result execution of the process at step S16, the GW cell 12 corresponding to the information of the GW cell which has been acquired at step S12 opens a channel leading to the router 4 with the use of the operation stage use PPPoE setting information.

The instructing unit 64 instructs the IT cell management unit 15 to start up the virtual machine 17 and the virtual router 18 corresponding to the information on the virtual machine 17 to be started-up and the virtual router 18 to be started-up which has been acquired at step S12 (step S17). Then, the send unit 65 sends the router 4 the IP address of the started-up virtual router 18 and sends the started-up virtual router 18 the IP address of the router 4 (step S18). As a result of execution of the process at step S18, the started-up virtual router 18 sets the “Ethernet over IP” function, that is, the function of IP-packetizing data and sending/receiving the IP-packetized data. Then, the started-up virtual router 18 communicates with the router 4 via the channel leading from the GW cell 12 to the router 4 on the basis of the IP address of the router 4. Likewise, the router 4 sets the “Ethernet over IP” function, that is, the function of IP-packetizing the data and sending/receiving the IP-packetized data. Then, the router 4 communicates with the virtual router 18 via the channel leading from the router 4 to the GW cell 12 on the basis of the IP address of the virtual router 18.

Owing to execution of the processes from step S11 to step S18, the router management unit 16 is allowed to assist the user PC 6 in gaining access to the virtual machine 17 via the router 4, the PPPoE network 3 (IP-VPN), the GW cell 12 and the virtual router 18.

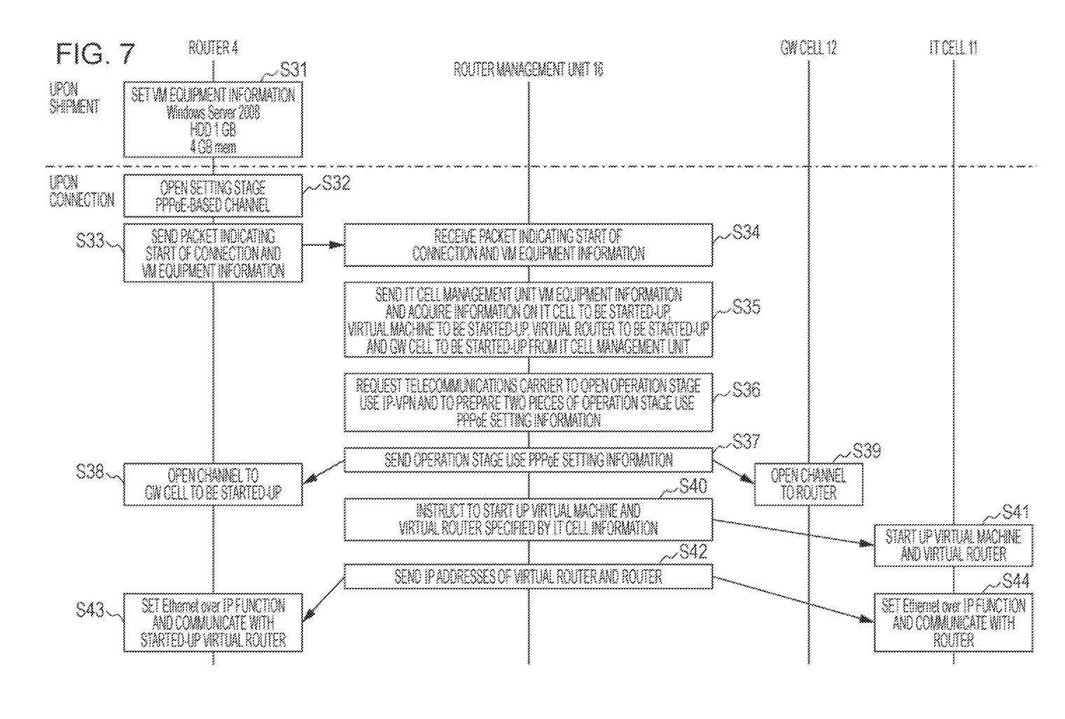

FIG. 7 is a diagram illustrating an example of a sequence of processes that the information management system 1 executes.

First, in shipping one router 4, VM equipment information is set in the memory 72 of the router 4 (step S31). Then, in connecting the router 4 with a network concerned, the PPPoE process unit 77 of the router 4 opens a channel leading to the GW cell 12 which is set up on the basis of a setting stage PPPoE with the use of setting stage use PPPoE setting information stored in the PPPoE authentication information DB 79 (step S32). The PPPoE process unit 77 of the router 4 sends the router management unit 16 a packet indicating start of connection and the VM equipment information (step S33).

The receive unit 61 of the router management unit 16 receives the packet indicating start of connection and the VM equipment information from the router 4 (step S34). The acquiring unit 63 of the router management unit 16 sends the IT cell management unit 15 the VM equipment information. Then, the acquiring unit 63 acquires information on a virtual machine 17 to be started-up, a virtual router 18 to be started-up, an IT cell 11 to be started-up and a GW cell 12 to be started-up from the IT cell management unit 15 (step S35). The requesting unit 62 of the router management unit 16 requests a telecommunications carrier to open an IP-VPN for use in the operation stage and to prepare two pieces of operation stage use PPPoE setting information (step S36). The telecommunications carrier opens the IP-VPN for use in the operation stage and sends the router management unit 16 two pieces of the prepared operation stage use PPPoE setting information in response to the request from the router management unit 16. The send unit 65 of the router management unit 16 sends the router 4 one piece of the operation stage use PPPoE setting information and sends the GW cell 12 to be started-up the other piece of the operation stage use PPPoE setting information (step S37).

The PPPoE process unit 77 of the router 4 opens a channel leading to the GW cell 12 to be started-up with the use of one piece of the operation stage use PPpoE setting information (step S38). Likewise, the GW cell 12 to be started-up opens a channel leading to the router 4 with the use of the other piece of the operation use stage PPPoE setting information (step S39). Owing to execution of the processes at step S38 and step S39, the router 4 and the GW cell 12 to be started-up are allowed to be connected with each other over a virtual private communication network using Ethernet.

Then, the instructing unit 64 of the router management unit 16 instructs the IT cell management unit 15 to start up the virtual machine 17 and the virtual router 18 corresponding to the information on the virtual machine 17 to be started-up and the virtual router 18 to be started-up which has been acquired at step S35 (step S40). The IT cell which is specified in accordance with the IT cell information acquired at step S35 starts up the virtual machine 17 and the virtual router 18 in response to the instruction from the IT cell management unit 15 (step S41).

Then, the send unit 65 of the router management unit 16 sends the router 4 the IP address of the started-up virtual router 18 and sends the started-up virtual router 18 the IP address of the router 4 (step S42). The router 4 receives the IP address of the started-up virtual router 18 from the router management unit 16. The router 4 sets the “Ethernet over IP” function and communicates with the started-up virtual router 18 via the channel leading from the router 4 to the GW cell 12 on the basis of the received IP address (step S43). The started-up virtual router in the IT cell 11 receives the IP address of the router 4 from the router management unit 16. The started-up virtual router 18 sets the “Ethernet over IP” function, that is, the function of IP-packetizing data and sending/receiving the IP-packetized data. Simultaneously with the above mentioned operation, the started-up virtual router 18 communicates with the router 4 via the channel leading from the GW cell 12 to the router 4 on the basis of the received IP address (step S44). Since the “Ethernet over IP” function is set in the started-up virtual router 18 and the router 4, it is allowed to create a state in which it seems as though the virtual machine 17 which is connected with the started-up virtual router 18 is directly coupled with the router 4 over Ethernet.

As described above, according to the above mentioned embodiment, the router 4 sends the router management unit 16 the VM equipment information when it has been connected with the PPPoE network 3. Then, the router 4 opens the channel leading to the GW cell 12 to be started up which has been specified on the basis of the VM equipment information by using the PPPoE-ID and the password. As a result, the channel between the router 4 and the GW cell 12 to be started-up is opened. In addition, the router 4 communicates with the virtual router 18 which is connected with the virtual machine 17 which has been stated up in accordance with the VM equipment information via the channel leading to the GW cell 12 on the basis of the IP address of the above mentioned virtual router 18. As a result, the router 4 and the started-up virtual router 18 are allowed to communicate with each other. Thus, the router 4 is allowed to create a state in which the user is allowed to use the virtual machine 17 that operates in the VM service data center 2 just like a server which is directly coupled with a LAN simply by connecting the router 4 with the PPPoE network 3. In addition, since the user is allowed to use the virtual machine 17 that operates in the VM service data center 2 simply by installing the router 4, the expenses that the user may bear for installation and operation of the system, that is, the running cost may be reduced.

In addition, the router management unit 16 of the management server 14 receives the VM equipment information from the router 4 when the router 4 has been connected with the PPPoE network 3. Then, the router management unit 16 sends the router 4 and the GW cell 12 to be started up which has been specified on the basis of the VM equipment information the PPPoE-ID and the password. As a result, the channel between the router 4 and the GW cell 12 to be started-up is opened. In addition, the router management unit 16 instructs the IT cell management unit 15 to start up the virtual machine 17 and the virtual router 18 which have been specified on the basis of the VM equipment information. As a result, the virtual machine 17 and the virtual router 18 are started up. Then, the router management unit 16 sends the router 4 the address of the started-up virtual machine 18 and sends the started-up virtual router 18 the address of the router 4. As a result, the router 4 and the started-up virtual router 18 come to communicate with each other. Thus, the router management unit 16 is allowed to create a state in which the user is allowed to use the virtual machine 17 just like a server which is directly coupled with a LAN simply by connecting the router 4 with the PPPoE network 3.

In addition, in the VM service data center 2, a process of acquiring the PPPoE-ID and the password and a process of starting up the virtual machine 17 concerned are executed in accordance with connection of the router 4 with the network. Thus, the VM service data center 2 is allowed to acquire the desirable number of PPPoE-IDs and the desirable number of passwords and hence is allowed to operate the desirable number of virtual machines 17.

Incidentally, a storage medium that stores programs of software for implementing the functions of the router management unit 16 may be supplied to the management server 14 so as to make the CPU 51 execute the programs stored in the storage medium. As storage media that store the programs, a CD-ROM (Compact Disk Read Only Memory), a DVD (Digital Versatile Disk), an SD (Source Digital) memory card and the like may be given by way of example.

The same effects as those brought about by the above mentioned embodiment may be attained by making the CPU 51 of the management server 14 execute software programs for implementing the functions of the router management unit 16.

What is claimed is:

1. A router comprising:
a sending module that sends information to a data center connected with a wide area network when the router has been connected with the wide area network, the information being registered in the router beforehand and including information relating to an information management device that starts up a virtual machine and a virtual router;
an opening module that acquires protocol setting information for a virtual private communication network from the data center and opens a channel leading to a gateway in the data center on the basis of the protocol setting information for a virtual private communication network; and
a communication module that acquires an address of the virtual router to be connected with the virtual machine which has been started up in the data center on the basis of the information relating to the information management device from the data center and communicates with the virtual router via the channel leading to the gateway in the data center on the basis of the acquired address of the virtual router.

2. The router according to claim 1, wherein
the protocol setting information for a virtual private communication network is identification information and a password of a PPPoE that the data center has acquired from a telecommunications carrier.

3. The router according to claim 1, wherein
the communication module sets an “Ethernet over IP” function.

4. The router according to claim 1, wherein
the opening module opens the channel leading to the gateway in the data center on the basis of the protocol setting information for a virtual private communication network before the information relating to the information management device is sent from the sending module and opens the channel leading to the gateway in the data center on the basis of setting information of a protocol for use in an operation stage virtual private communication network which has been acquired from the data center after the information relating to the information management device has been sent from the sending module.

5. An information processing device comprising:
a receiving module that receives information relating to an information management device that starts up a virtual machine and a virtual router from a router when the router has been connected with a wide area network;
a first acquiring module that acquires the information on an information management device to be started up, a virtual machine to be started up, a virtual router to be started up and a gateway to be started up which are held in a data center on the basis of the received information relating to the information management device;
a second acquiring module that acquires two pieces of protocol setting information for a virtual private communication network from a telecommunications carrier;
a first sending module that sends the router one piece of the acquired protocol setting information for a virtual private communication network and sends a gateway corresponding to information on the gateway to be started up the other piece of the acquired protocol setting information for a virtual private communication network;
an instructing module that instructs the information management device to start up the virtual machine and the virtual router corresponding to the information on the virtual machine to be started and the virtual router to be started up; and
a second sending module that sends the router the address of the started-up virtual router and sends the started-up virtual router the address of the router.

6. The information processing device according to claim 5, further comprising:
a data base in which information relating to the information management device is registered in correspondence with information on the information management device to be started up, the virtual machine to be started up, the virtual router to be started up and the gateway to be started up that the data center holds, wherein
the first acquiring module acquires information on the information management device to be started up, the virtual machine to be started up, the virtual router to be started up and the gateway to be started up that the data base holds on the basis of the data base and the received information relating to the information management device.

7. The information processing device according to claim 5, wherein
the protocol setting information for a virtual private communication network includes an identification information and a password of a PPPoE.

8. A computer-readable, non-transitory medium storing a computer program a program that causes an information processing device to execute a process, the process comprising:
receiving information relating to an information management device that starts up a virtual machine and a virtual router from a router when the router has been connected with a wide area network;
acquiring information on the information management device to be started up, the virtual machine to be started up, the virtual router to be started up and a gateway to be started up which are held in a data center on the basis of the received information relating to the information management device;
acquiring two pieces of protocol setting information for a virtual private communication network from a telecommunications carrier;
sending the router one piece of the acquired protocol setting information for a virtual private communication network and sends a gateway corresponding to information on the gateway to be started up the other piece of the acquired protocol setting information for a virtual private communication network;
instructing the information management device to start up the virtual machine and the virtual router corresponding to the information on the virtual machine to be started and the virtual router to be started up; and
sending the router the address of the started-up virtual router and sends the started-up virtual router the address of the router.
